(19) United States
(12) Patent Application Publication
(10) Pub. No.: US 2011/0071026 A1
(43) Pub. Date: Mar. 24, 2011

(54) LOW VISCOSITY, AQUEOUS GLYPHOSATE SALT CONCENTRATES

(76) Inventors: Volker Heide, Memphis, TN (US); Marshall B. Wixson, Collierville, TN (US)

(21) Appl. No.: 12/562,644

(22) Filed: Sep. 18, 2009

(51) Int. Cl. A01N 57/18

(52) U.S. Cl. 504/206

(57) ABSTRACT

The present invention provides a low viscosity, aqueous concentrate comprising a primary amine salt of glyphosate and surfactant. The aqueous concentrate can be formed from a highly concentrated glyphosate composition that has very low levels of glyphosate in non-salt form. Exemplary aqueous concentrates include a primary amine salt of glyphosate in the range of 45 percent weight to 68 percent weight, and a surfactant at a concentration in the range of 3 percent weight to 27 percent weight, with the concentrate having a viscosity in the range of 40 to 450 centistokes.

### FIELD OF INVENTION

The present invention is directed to aqueous concentrate compositions that contain a primary amine salt of glyphosate.

### BACKGROUND OF THE INVENTION

Glyphosate (N-phosphonomethyl glycine) is a well-known, non-selective herbicide that is commonly applied to control the growth of plants in a post-emergent manner. Glyphosate exhibits its herbicidal effects by inhibiting the shikimic acid pathway in plants. By inhibiting the shikimic acid pathway, the synthesis of aromatic amino acids and other secondary metabolites becomes obstructed. The obstruction disrupts protein synthesis, which ultimately results in plant death.

Aqueous glyphosate salt formulations have been preferred from a commercial standpoint. The acid form of glyphosate has a low solubility in water and therefore glyphosate is typically in salt form in aqueous compositions. In addition, glyphosate in salt form is significantly more biologically effective than glyphosate acid. Various salt forms of glyphosate, which can be used in aqueous compositions, have been described in the art (see, for example, U.S. Pat. Nos. 3,799,758, 4,140,513, 4,315,765, 4,481,026, and 4,507,250). In particular, aqueous compositions containing the monoisopropylamine (MIPA) salt of glyphosate have wide commercial use.

Some aqueous glyphosate salt compositions are sold in the form of concentrates. These concentrates are typically diluted prior to plant treatment and often include activity-enhancing surfactants. Surfactants can enhance herbicide function by performing one or more of the following functions: increase herbicide solubility in water, act as a cosolvent for the herbicide, reduce surface tension of spray droplets (which can result in increased droplet retention on vegetation and spread on a leaf surface), and solubilization of cuticular leaf waxes.

Herbicide compositions in concentrate form can provide many advantages, such as in reduction in storage space, reduction in packaging material (e.g., container material), and improvements in shipping and handling efficiencies. Despite the advantages that liquid concentrates offer, there are various technical challenges associated with their use. For example, at high herbicide concentrations, and with the addition of additional components such as surfactants, the viscosity of the liquid concentrate can be very high. High viscosity can make the composition very difficult to handle, and create problems such as with pumping and measuring the composition. As such, high viscosity can present many difficulties for the end user, typically one who prepares an application composition from the liquid concentrate. Lower temperatures can also increase the viscosity of the liquid concentrates, making use in colder climates or colder months more difficult.

The presence of surfactants can also present technical challenges in liquid concentrates. For example, it is known that some surfactants can reduce efficacy of glyphosate salt by interacting with it. It is also known that surfactants can increase the viscosity of the herbicidal formulation, further adding to the difficulties of high viscosities associated with high concentration liquid formulations.

Yet another technical challenge relates to the physical stability of the composition, as well as the herbicide active that is contained therein. Storage of concentrate compositions at low temperatures can result in the precipitation, crystallization, or sedimentation of the herbicide active and/or secondary components, such as surfactants, out of the composition. Storage of concentrate compositions at high temperatures can result in the phase separation of components of the composition. These types of changes are generally undesirable as they can render the liquid concentrate composition unusable, or may require one or more corrective processing steps to return the liquid concentrate to a usable form.

According to estimates from the U.S. Environmental Protection Agency, global herbicide use was approximately 2.0 billion pounds in 2000 and 2001. In the U.S., for combined agricultural and home applications, glyphosate was the most used herbicide in 2001. Improvements in glyphosate technology, particularly ones that allow for reductions in material handling, mixing, packaging, and freight, can have a significant impact on the carbon footprint associated with glyphosate use.

The current invention provides methods and compositions that not only offer technical advantages associated with glyphosate use, but that also are more environmentally friendly and economical.

### SUMMARY OF THE INVENTION

Generally, the invention is directed to a surfactant-containing glyphosate salt aqueous concentrate (also herein “aqueous concentrate”). The aqueous concentrate comprises a primary amine salt of glyphosate and a surfactant. Although the glyphosate salt is present at a very high concentration in the aqueous concentrate, it displays very good viscosity and storage stability properties.

The invention also provides methods for preparing the aqueous concentrate, methods for preparing herbicide application compositions from the aqueous concentrate, application compositions made from the aqueous concentrate, and methods for controlling plant growth using the application compositions.

In one aspect, the invention provides a surfactant-containing glyphosate salt aqueous concentrate that is storage-stable and that has a low viscosity. The aqueous concentrate comprises a primary amine salt of glyphosate and a surfactant. The concentration of the primary amine salt of glyphosate is in the range of 45 percent weight to 68 percent weight in the aqueous concentrate. The concentration of the surfactant in the aqueous concentrate is in the range of 3 percent weight to 27 percent weight. The aqueous concentrate also has a viscosity in the range of 40 to 450 centistokes (cSt).

An exemplary glyphosate salt for use in the aqueous concentrate is glyphosate-monoisopropylammonium (glyphosate-MIPA). Also, an exemplary surfactant for use in the composition is an alkoxylated alkyl amine surfactant.

The invention also provides methods for forming the surfactant-containing glyphosate salt aqueous concentrate. In one mode of practice, the aqueous concentrate is formed using a high strength aqueous glyphosate salt concentrate (also herein “high strength concentrate”). The high strength concentrate has a very high concentration of the glyphosate salt, with low levels of microparticulates, and/or unreacted glyphosate acid. The properties of the high strength concentrate carry over to provide benefits to the aqueous concentrate.

The invention also provides methods for preparing surfactant-containing glyphosate salt aqueous concentrates. Generally, to form the aqueous concentrate, a surfactant composition containing a minimal amount of water, or no water, is combined with a high strength concentrate. The methods provide surfactant-containing aqueous concentrates having a high concentration of the glyphosate salt, and very good viscosity. The method and surfactant-containing concentrates of the prior art provide improvements over surfactant-containing glyphosate salt concentrates of the prior art. The concentrates of the current invention, in addition to having commercially acceptable viscosity, can be diluted to provide application compositions having amounts of glyphosate and surfactant sufficient to achieve weed control. The present invention overcomes difficulties in providing a concentrate having a high concentration of glyphosate salt (e.g., above 41 percent weight) and an amount of surfactant useful for achieving weed control when the concentrate is diluted to an application composition. The invention achieves this without increasing the viscosity of the concentrate to commercially unacceptable levels.

In one aspect, the surfactant-containing glyphosate salt aqueous concentrate is formed by a method including a step of providing a glyphosate acid preparation having water content of 35 percent weight or less, or preferably 5 percent weight or less. Also, a primary amine preparation is provided comprising primary amine in amount of 70 percent weight or greater, or preferably 95 percent weight or greater. A step of combining water with the glyphosate acid preparation to provide a glyphosate acid slurry is then performed. The amount of water combined is in the range of 25% to 35% of a total amount of material from the glyphosate acid preparation and primary amine preparation used to form a high-strength glyphosate salt aqueous concentrate. Next, a step of adding the primary amine preparation to the glyphosate acid slurry to create a reaction mixture is performed. In the reaction mixture the primary amine reacts with the glyphosate acid to form a primary amine salt of glyphosate, thereby producing a high-strength glyphosate salt aqueous concentrate. After this, a surfactant composition is combined with the high-strength glyphosate salt aqueous concentrate to form a surfactant-containing, aqueous glyphosate salt concentrate, wherein surfactant is present in the surfactant composition in an amount of greater than 50 percent weight.

In another aspect, the surfactant-containing glyphosate salt aqueous concentrates is formed by a method including a step of providing a high-strength glyphosate salt aqueous concentrate comprising a primary amine salt of glyphosate in an amount of 63 percent weight or greater. The high-strength glyphosate salt aqueous concentrate comprises less than one percent weight unreacted glyphosate acid, and/or less than one percent weight glyphosate particulates of a size greater than 1 μm. After this, a surfactant composition is combined with the high-strength glyphosate salt aqueous concentrate to form a surfactant-containing, aqueous glyphosate salt concentrate, wherein surfactant is present in the surfactant composition in an amount of greater than 50 percent weight.

The inventive aqueous concentrate provides various advantages for the preparation, handling, and application of glyphosate herbicide compositions. For example, with regards to shipping and handling, the desirable viscosity allows the user to more easily measure and transfer (e.g., by pumping) the aqueous concentrate. With regards to storage, the improved stability affords the manufacturer, shipper, and user a greater amount of time between the formulation of the aqueous concentrate, and when it is actually used. Also afforded is more flexibility with regards to storage conditions. With this in mind, overall, use of the inventive aqueous concentrate provides a distinct economic advantage.

Because glyphosate salt can be present at a very high concentration in the aqueous concentrate, the invention also provides advantages that are reflected in one or more of the following reductions: material handling, mixing, packaging, and freight. By providing any one or more of these reductions, the carbon footprint associated with glyphosate use can accordingly be reduced. The method and compositions of the invention are therefore more environmentally friendly and economical.

Other aspects of the invention are related to methods for using the aqueous concentrate to form herbicide application compositions. For example, an application composition can be prepared by diluting the aqueous concentrate with water. The invention also provides methods for controlling the growth of vegetation comprising a step of applying the herbicide application composition in a post-emergent or a pre-emergent manner.

### DETAILED DESCRIPTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Generally, the invention provides a surfactant-containing glyphosate salt aqueous concentrate (“aqueous concentrate”). The aqueous concentrate includes a primary amine salt of glyphosate (such as glyphosate IPA) and a surfactant. An exemplary aqueous concentrate comprises glyphosate-IPA salt and an alkoxylated alkyl amine surfactant. The aqueous concentrate displays good viscosity and good storage-stability.

In one mode of practice, the aqueous concentrate is prepared starting with a high strength aqueous glyphosate salt concentrate (“high strength concentrate”), which is a very highly concentrated glyphosate salt aqueous composition. The high strength concentrate generally has about 63 percent weight or greater, of a primary amine salt of glyphosate in water. More specifically, the primary amine salt of glyphosate can be at a concentration in the high strength concentrate of about 65 percent weight or greater, or 67 percent weight or greater, such as about 68 percent weight. The high strength concentrate is typically in the form of a clear, homogeneous salt solution. Typically, the high strength concentrate does not include excipient component(s) (e.g., a surfactant) in any appreciable amount(s).

High strength concentrates containing glyphosate salt, and methods for forming high strength concentrates, are discussed in the U.S. non-provisional application filed Sep. 18, 2009, titled “High Strength Aqueous Glyphosate Salt Concentrates and Methods,” bearing attorney docket no. HAI0003/US, in the names of inventors including Heide, Volker, and Wixson, Marshall.

In order to describe the surfactant-containing glyphosate salt aqueous concentrate, the preparation of a high strength concentrate is also discussed. As a general matter, high strength concentrates are prepared by the combination of glyphosate acid with a primary amine (base) in the presence of water. Glyphosate acid, which has a low solubility in water, is converted to a highly soluble salt form upon addition of the primary amine.

The terms “glyphosate acid” and “glyphosate”, as used herein, refer to fully protonated or deprotonated forms of the acid. Glyphosate acid has the structure:

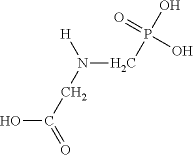

(C₃H₈NO₅P), a molecular weight of 169.1 Da, and the chemical name N-(phosphonomethyl)glycine. Glyphosphate in acid form has a very low solubility in water (about 12 g/L at 25° C.). On the other hand, most salt forms of glyphosate are at least very soluble in water. The acid dissociation constants for glyphosate are pKa₁ 0.8 (first phosphonic), pKa₂ 2.3 (carboxylate), pKa₃ 6.0 (second phosphonic), and pKa₄ 11.0 (amine). In an aqueous solution, glyphosate has a tendency to dissociate one proton from the phosphonic acidic group and associate that proton with the amine group, forming a dipolar molecule (zwitterion).

In one mode of practice, in order to prepare a high-strength aqueous concentrate, a high purity, low water content glyphosate acid preparation is provided. The glyphosate acid preparation can be a product of any particular known synthetic processes for preparing glyphosate acid. Various routes for the synthesis of glyphosate acid are known in the art.

One route, the “glycine route,” involves the phosphonomethylation of glycine. For example, cholormethyl-phosphonic acid can be reacted with glycine in basic conditions. In another glycine route, dimethyl phosphate is reacted with glycine to form glyphosate.

Another route is the catalytic oxidation of N-(phosphonomethyl)iminodiacetic acid (PMIDA) (see, for example, U.S. Pat. No. 3,954,848). The PMIDA route generally involves mixing PMIDA with water and an acid (such as sulfuric acid), and then heating the mixture to an elevated temperature. An oxidizing agent (such as an inorganic peroxide, like hydrogen peroxide, or an organic peroxide) is then added, which oxidatively converts iminodiacetic acid to glyphosate acid. Oxidation can be performed in the presence of a noble metal catalyst such as platinum, immobilized on a support. Precipitation of glyphosate acid can be achieved by precipitation, using a water-miscible organic solvent. Decomposition products observed using the PMIDA route can include glyphosine, glycine, iminodiacetic acid, M-formylglyphosate, PMIDA, (aminomethyl)phophonic acid (APMA), N-methyl-N-(phosphonomethyl glycine (MePMG), and N-N bis(phosphonomethyl)amine (bPMNH).

Glyphosate can also be produced by the phosphonomethylation of N-benzylglycine to N-benzyl glyphosate, followed by reaction with hydrobromic or hydroiodic acid to cleave the benzyl group, which produces glyphosate (see U.S. Pat. No. 3,956,370). Glyphosate can also be produced by the phosphonomethylation of N-t-butyl glycine to form N-t-butyl glyphosate, which is then converted to glyphosate via acid hydrolysis. Processes using N-benzylglycine or N-t-butylglycine as starting materials can produce byproducts such as isobutylene and toluene.

In some aspects the glyphosate acid preparation used to form the high-strength aqueous concentrate has a water content of about 35 percent weight or less, such as in the range of about 0.01 percent weight to about 35 percent weight. Preferably, the glyphosate acid preparation has a water content of about 5 percent weight or less. For example, in some aspects, the glyphosate acid preparation used to prepare the high-strength aqueous concentrate has a water content of about 4 percent weight or less, about 3 percent weight or less, or about 2 percent weight or less. For example, in some aspects the glyphosate acid preparation has a water content in the range of about 0.01 percent weight to about 5 percent weight, or more specifically in the range of about 0.01 percent weight to about 2 percent weight. The water content is the amount of water by weight of all material (liquid and solid) present in the glyphosate acid preparation. For example, in 100 g of a glyphosate acid preparation having a water content of 5 percent weight, there is 95 g of solids and 5 g of water.

The low water content significantly reduces the amount of water-soluble impurities or liquid impurities that are associated with the glyphosate acid preparation. For example, by using a glyphosate acid preparation with a water content of 5 percent weight or less, impurities such as formaldehyde and nitrosamines are substantially removed. For example, in some aspects, the glyphosate acid preparation has less than 1 percent weight formaldehyde, and/or less than 1 percent weight nitrosamines. (Examples of nitrosamine impurities include N-nitrosodialkylamines, wherein the alkyl is methyl, ethyl, propyl, or butyl, and N-nitrosopiperidine, N-nitrosopyrrolidine, and N-nitrosomorpholine). Carbon is another impurity that may be associated with the glyphosate acid preparation. These types of impurities are though to nucleate formation of undesirable glyphosate acid particulates. By removing these particulates, it significantly minimizes particulate formation, which in turn results in a high-strength aqueous concentrate with improved properties. These improved properties include good viscosity and a high concentration of glyphosate in its biologically effective form.

In some aspects, the glyphosate acid preparation used to form the high-strength aqueous concentrate includes glyphosate acid at 98 percent weight of total solids, or greater, or 99 percent weight of total solids, or greater. For example, as a percentage of the solids in the composition, the total non-glyphosate solids are present in the glyphosate acid preparation used in an amount in the range of about 0.01 percent weight to about 2 percent weight, or more specifically in the range of about 0.01 percent weight to about 1 percent weight.

Generally, a glyphosate acid preparation having a very low water content (e.g., about 5 percent weight or less) is in the form of a dry material (e.g., a dry flake or pellet), whereas a glyphosate acid preparation having a higher water content (e.g., about 10 percent weight) is in the form of a wet cake.

If desired, in order to lower the amount of moisture, the glyphosate acid preparation can be subjected to a low-pressure environment, heat, blown air, or combinations thereof. This can also be helpful in driving off volatile impurities, such as formaldehyde and nitrosamines. A low-pressure treatment can be performed prior to combining the glyphosate acid with the primary amine salt.

A primary amine preparation is also used to form the high-strength aqueous concentrate. A primary amine preparation refers to an amine base of the general formula: H₂NR, wherein R is a linear or branched alkyl radical having 2-6 carbon atoms. Examples of primary amines useful for forming a glyphosate primary amine salt in an aqueous concentrate include monoisopropyl amine, mono-n-propylamine, and monobutylamine.

The primary amine preparation used to form the glyphosate salt of the high-strength aqueous concentrate also has high purity. In the primary amine preparation, any non-primary amine component(s) are present in an amount of about 2 percent weight or less, or about 1 percent weight or less.

In a preferred mode of practice, the primary amine base used to form the glyphosate salt is monoisopropyl amine (MIPA, also IPA or isopropylamine). Monoisopropylamine is a highly hygroscopic colorless liquid that is miscible with water. In some aspects, the primary amine preparation comprises MIPA at 70 percent weight or greater, such as in the range of 70-99.9 percent weight. More preferably, the primary amine preparation comprises MIPA at 95 percent weight or greater, such as in the range of 95-99.9 percent weight.

For example, the primary amine preparation can have a water content of about 2 percent weight or less, such as in the range of about 0.01 percent weight to about 2 percent weight, or about 0.01 percent weight to about 1 percent weight. Accordingly, the amount of the primary amine in the primary amine preparation is about 98 percent weight or greater, such as in the range of about 98 percent weight to about 99.9 percent weight, or about 99 percent weight to about 99.9 percent weight.

In the process of preparing the high-strength aqueous concentrate, the glyphosate acid and the primary amine are reacted in a limited amount of water. Preferably, purified water is used. Purified water for the composition can come from, for example, a filtration process, a deionization process, or a distillation process.

The method of preparing the high-strength aqueous concentrate includes a step of combining water with the glyphosate acid preparation to form a glyphosate acid slurry. After the slurry is formed, primary amine is added to the slurry, which reacts with the glyphosate acid. The amount of water that is combined to form the slurry can be described relative to the total amount of glyphosate acid and primary amine used to form the high-strength aqueous concentrate. In the step of forming the slurry, an amount of water in the range of about 25% to about 35% of a total amount of material from the glyphosate acid preparation and primary amine preparation is combined with the glyphosate acid preparation. For example, if 200 g of the glyphosate acid preparation and 60 g of primary amine preparation is used to make the concentrate (260 g total material), an amount of water from about 65 g up to about 91 g can be combined with the glyphosate acid preparation to form the glyphosate acid slurry. In more specific aspects, an amount of water in the range of about 27.5% to about 32.5% of a total amount of material from the glyphosate acid preparation and primary amine preparation is combined with the glyphosate acid preparation.

The recited ranges of water can also take into account any pre-existing water carried over from the starting glyphosate acid and/or primary amine preparations. The greater the moisture content in the glyphosate acid and/or primary amine preparations, the less water will be needed to be combined with the glyphosate acid and primary amine ingredients to form the high-strength aqueous concentrate.

In the step of combining, purified water can be combined with the glyphosate acid preparation. Since glyphosate acid has a low solubility in water, the addition of water can transform the glyphosate acid preparation from a dry flake into an aqueous slurry, which generally is in the form of a thick suspension of solids in a liquid. (After the addition of the primary amine base, the slurry or suspension is transformed into a clear concentrate by the reaction of the base with the acid, and formation of the glyphosate salt.) If desired, mixing equipment can be used to facilitate preparation of the slurry. During and/or after combining the water the glyphosate acid, the slurry can be maintained at a desired temperature. For example, the slurry is maintained at a temperature of below about 120° C. (below about 49° C.). Lower temperatures can be useful, since the next step of adding the primary amine is understood to result in an exothermic reaction.

Next, a primary amine preparation is added to the glyphosate acid slurry. The step of addition results in a “reaction mixture” of glyphosate acid with the primary amine base, which results in the formation of the primary amine salt of glyphosate in a high strength aqueous concentrate. The reaction, in essence, transforms the low solubility glyphosate acid into the highly soluble glyphosate salt, which is solubilized by the water in the reaction mixture.

Typically, the addition of the primary amine is carried out using mixing or some form of agitation to facilitate the rapid distribution and reaction of the primary amine with the glyphosate acid in the mixture. Mixing can also help ensure that the heat generated by the exothermic reaction becomes more evenly distributed throughout the mixture.

During addition of the primary amine, the reaction mixture can be treated so that it is maintained within a desired temperature range. Typically, the reaction mixture is cooled since addition of primary amine is understood to result in an exothermic reaction. In some aspects, the reaction mixture is cooled to a temperature in the range of about 90° F. to below about 140° F. (about 32° C. to below about 60° C.), in the range of about 90° F. to about 120° F. (about 32° C. to about 49° C.), or in the range of about 105° F. to about 120° F. (about 40.5° C. to about 49° C.).

The primary amine can be added to the glyphosate acid slurry at a rate that drives reaction of the glyphosate acid with the primary amine towards completion, and promotes complete or substantially complete formation of the glyphosate salt. The rate of addition of the primary amine can be chosen based on one or more factors, such as the temperatures of the ingredients being combined, the batch size of the high strength aqueous concentrate to be made, as well as the rate of any mixing or agitation that is performed while the primary amine is added to the slurry of glyphosate acid.

In some modes of practice, the primary amine is added to the slurry of glyphosate acid at a rate in the range of about 2.1% to about 3.2% per minute. Rate of addition of the primary amine can be calculated by the amount of primary amine added to the glyphosate slurry per minute divided by the total amount of primary amine and glyphosate acid used to make the high strength aqueous concentrate. For example, if 100 kg of glyphosate acid and 41.7 kg of primary amine are used to make the high strength aqueous concentrate, and if primary amine is added to the glyphosate acid slurry at 3.54 kg/min, the rate of addition is 2.5% per minute.

A preferred primary amine base is monoisopropyl amine (MIPA). MIPA is in liquid form at temperatures lower than 32° C., and can, be metered into the glyphosate acid slurry.

Generally, an amount of primary amine is added to the glyphosate acid slurry to facilitate a high rate of reaction with the glyphosate acid. In some aspects, the primary amine is added in a molar excess relative to the glyphosate acid. For example, an amount of primary amine can be added to provide a molar ratio of glyphosate acid to primary amine in the range of about 1:1 to about 1:1.2, respectively. In the case of a high-strength aqueous concentrate of glyphosate-IPA, glyphosate acid is added in a mass amount of about three times that of IPA (i.e., a 3:1 weight ratio, such as 75 g of glyphosate acid and 25 g of IPA), which falls within the molar range.

Generally, greater than 90 percent of the glyphosate acid in the glyphosate acid slurry reacts with the primary amine to form the primary amine salt of glyphosate.

After the primary amine is added, the reaction results in glyphosate acid being converted into a glyphosate salt (for example, glyphosate-IPA), wherein glyphosate salt is in soluble form in the high-strength aqueous concentrate. At this point, the concentration of glyphosate salt can be very high, such as about 75 percent weight or greater, for example, between about 75 percent weight to about 80 percent weight.

This high-strength aqueous concentrate can then be diluted with water to provide a “second” high-strength aqueous concentrate that has a glyphosate salt at a concentration commonly found in commercial use. Surfactant does not have to be added at this point. For example, an amount of water added can provide a second high-strength aqueous concentrate with a glyphosate salt concentration in the range of 60 percent weight to about 75 percent weight, about 63 percent weight to about 70 percent weight, about 65 percent weight to about 70 percent weight, or about 67 percent weight to about 70 percent weight.

The high-strength aqueous concentrate (or more dilute second high strength concentrate) can also be analyzed to determine properties such as viscosity, quantity of unreacted glyphosate acid, the presence of impurities, and the presence and quantity of particulates. In order to determine the effectiveness of the method of forming the high strength aqueous concentrate, analysis can be carried out before any optional supplemental treatment of the high-strength aqueous concentrate (such as filtration, which can further improve the quality of the high-strength aqueous concentrate).

Because of the high purity of reagents used to form the high-strength aqueous concentrate, the amount of unreacted glyphosate acid and/or particulates is very low. If any unreacted glyphosate acid is present, it typically is in the form of a glyphosate acid particulate, which is considered a biologically ineffective component of a herbicide composition.

The presence and amount of glyphosate acid particulates can be determined using common techniques. For example, the presence of particulates can be determined microscopically, or by using a flow cytometer. The quantity of particulates can be determined using centrifugation. For example, a sample of the high-strength aqueous concentrate can be subjected to centrifugation to pellet glyphosate acid particulates. Sedimentation centrifugation is a common technique for removing particles of a selected size distribution from a suspension of fine solids in liquids. The high-strength aqueous concentrate with soluble glyphosate salt can be decanted, and then the pellet can be weighed to determine the quantity of particulates relative to a volume of high-strength aqueous concentrate, or relative to the amount of glyphosate salt in the high-strength aqueous concentrate.

In some aspects, the method of the invention produces a high-strength aqueous concentrate with an amount of particulates having a size of about 1 μm or greater, in an amount of about one percent of the weight, or less, of the glyphosate salt in the concentrate.

The pH of the high-strength aqueous concentrate can also be determined using standard techniques. In some aspects, the high-strength aqueous concentrate has a pH in the range of about 3 to about 6, or more specifically in the range of about 4 to about 4.8.

The high-strength aqueous concentrate (or more dilute second high-strength concentrate) can optionally be subjected to additional treatment(s) to improve the quality of the concentrate. For example, the high-strength aqueous concentrate can be subjected to one or more filtration steps. The filtration steps can remove particulates that may be present in the high-strength aqueous concentrate. Since the method of the invention already results in a low particulate level (without supplemental treatment) that, in turn, provides good viscosity, and makes the high-strength aqueous concentrate is easier to filter.

One or more optional steps of filtration, in turn, can further improve properties of the high-strength aqueous concentrate, such as by further lowering its viscosity.

A filtration step can include the use of a coarse filter to remove large particulates. Exemplary coarse filters have pore sizes in the range of about 10 to 200 microns. Generally, a 10 micron filter will trap particulates having a smallest dimension of about 10 microns or greater on the filter, while allowing particles of smaller to flow through. (Particulates have spherical and cubical shapes generally have their largest dimension on the order of their smallest dimension, whereas the smallest dimension of rod shaped particles corresponds to their width, not length.)

A coarse filter can be used with vacuum filtration to pull the high-strength aqueous concentrate through the filter and remove the particulates. In some aspects, filtration is performed while the high-strength aqueous concentrate is still very warm, for example at a temperature in the range of about 95° F. to about 113° F. (about 35° C. to about 45° C.).

Another treatment involves the use of a fine filter to remove smaller particulates such as those that flow through the large filter. For example, the high-strength aqueous concentrate (or more dilute second high-strength concentrate) can be filtered through a fine filter having a pore size of about 1 micron. A fine filter can be used in a single filtration step of the high-strength aqueous concentrate, or can be used to remove smaller particulates following coarse filtration. Fine filtration can therefore further reduce the amount of particulates that are present in the aqueous concentrate.

In some modes of practice filtration can be performed after addition of surfactant. For example, the high strength concentrate is filtered using a course filter, a surfactant is then added to prepare a surfactant-containing aqueous concentrate, and then the surfactant-containing aqueous concentrate is filtered using a fine filter.

The high strength concentrate can be used for the formation of the surfactant-containing glyphosate salt aqueous concentrate (“aqueous concentrate”). In some modes of forming the aqueous concentrate, a process is carried out so that a nominal amount of water is introduced into the high strength concentrate along with surfactant. Minimizing the amount of water introduced provides an aqueous concentrate where a higher concentration of the primary amine glyphosate salt is maintained. To accomplish aqueous concentrate formation, surfactant can be added in a concentrated form.

A surfactant composition can also be added to the high strength concentrate to form the aqueous concentrate. The surfactant composition can include one or more surfactants. In some cases, the surfactant composition can also include a diluent, such as water and/or one or more other liquids. Exemplary non-water diluents for the surfactant composition include diethylene glycol and propylene glycol. An exemplary concentrated surfactant composition includes surfactant in an amount of about 50 percent weight or greater in the composition, such as in the range of about 70 percent weight to about 100 percent weight.

In other cases, surfactant is added in “neat” form, meaning that there are at most trace amounts of non-surfactant material(s) present along with surfactant. Surfactants can be in solid or liquid neat form.

A single surfactant type, or a combination of two or more different surfactants can be used to form the aqueous concentrate. Generally, an amount of surfactant is added to the high strength concentrate (or more dilute second high-strength concentrate) so the concentration of the glyphosate salt does not fall below about 45 percent weight. More preferably, surfactant is added to the concentrated glyphosate salt composition so the concentration of the glyphosate salt does not fall below about 46 percent weight, below about 47 percent weight, below about 48 percent weight, below about 49 percent weight, below about 50 percent weight, below about 51 percent weight, below about 52 percent weight, below about 53 percent weight, below about 54 percent weight, below about 55 percent weight, or most preferably below about 56 percent weight.

Exemplary concentration ranges of the glyphosate salt in the aqueous concentrate are from about 45 percent weight to about 68 percent weight, from about 48 percent weight to about 68 percent weight, from about 50 percent weight to about 68 percent weight, from about 51 percent weight to about 68 percent weight, from about 52 percent weight to about 68 percent weight, from about 53 percent weight to about 68 percent weight, from about 54 percent weight to about 68 percent weight, or most preferably from about 55 percent weight to about 67 percent weight.

Ranges of surfactant in the aqueous concentrate are from about 3 percent weight to about 27 percent weight, more preferably from 3 percent weight to about 7 percent weight, and most preferably from about 4 percent weight to about 6 percent weight.

In more specific aspects, the concentration of primary amine salt of glyphosate in the aqueous concentrate is in the range of about 55 percent weight to about 67 percent weight and surfactant is in the range of about 4 percent weight to about 6 percent weight. An exemplary aqueous concentrate includes about 58 percent weight of glyphosate IPA, and about 5 percent weight surfactant.

Accordingly, in aspects of the invention providing an aqueous concentrate wherein the presence of non-glyphosate salt components and non-surfactant components (other than water) are minimized, the invention provides an aqueous concentrate consisting essentially of a primary amine salt of glyphosate in an amount in the range of 45 percent weight to 66 percent weight, and a surfactant at a concentration in the range of 3 percent weight to 7 percent weight. In other words, in these aspects, the aqueous concentrates do not include materials other than the primary amine salt of glyphosate, surfactant, a minimal amount unreacted glyphosate acid or glyphosate particulates, and water, in any substantial amount.

In order to prepare the aqueous concentrate, surfactant can be combined with the high-strength concentrate. The step of combining can be performed at a desired temperature, typically in the range of about 0° C. to about 50° C., and more preferably after the high strength concentrate has cooled to a temperature below about 35° C., such as in the range of about 0° C. to below about 35° C. Surfactant can be added to the high strength concentrate batch wise, in a continuous manner (for example, with metering), or in a semi-continuous manner. Active mixing (by stirring or agitation) can be performed to facilitate formation of the mixing of the aqueous concentrate. Surfactant can be combined with the high strength concentrate in an appropriate mixing vessel, such as one that accommodates the volume of aqueous concentrate to be made. The mixing vessel can include features such as an agitator (e.g., paddle or propeller type), a heating or cooling jacket, and baffles.

Types of surfactants that can be present in the aqueous concentrate include cationic surfactants, anionic surfactants, non-ionic surfactants, ionic surfactants, and amphoteric surfactants. Combinations of two or more surfactants can be used to form the aqueous concentrate.

An exemplary aqueous concentrate is described with regards to an alkoxylated alkyl amine surfactant. However, any known surfactant, or combination of surfactants, can be combined with the high-strength (or secondary high-strength) concentrate to form the aqueous concentrate.

Exemplary alkoxylated alkyl amine surfactants include those having the formula R¹NR²R³, wherein R¹ includes a hydrocarbon group having 8 or more carbon atoms, and R² and R³ are independently selected from oxyalkylene polymeric chains. In some aspects R¹ is a C₈₋₂₂ alkyl group. In some aspects R² and R³ are respectively represented by (R⁴—O)ₘ—X and (R⁴—O)ₙ—X, wherein in R² and R³, R⁴ is independently C₂₋₄ alkene, and m and n have a combined value in the range of 2 to about 50.

Exemplary alkoxylated alkyl amine surfactants include polyoxyalkylene derivatives of tallowamine, cocoamine, and oleoylamine. In preferred aspects, the alkoxylated alkyl amine surfactant is polyoxyalkylene tallow amine. In preferred aspects, the alkoxylated alkyl amine surfactant has 2 to about 15 ethylene oxide groups (EO) per amine, or from about 5 to about 10 EO groups per amine.

Commercially available alkoxylated alkyl amine surfactants include, for example, Ethomeen™ C/15, Ethomeen™ T/15, and Ethomeen™ T/20 (Akzo Nobel).

Another surfactant type that can be present in the aqueous concentrate is a quaternary ammonium-based surfactant. Quaternary ammonium surfactants include those with alkylation, ethoxylation, or propoxylation, or combinations thereof. Exemplary quaternary ammonium surfactants are commercially available under the trademarks Ethoquad™ and Arquad™ (AkzoNobel, Chicago, Ill.), EMCOL™ CC (Witco Chemical). Quaternary ammonium glycoside surfactants are also described in JP 4-193891 and WO 99/10462.

Another surfactant type that can be present in the aqueous concentrate is an alkyl glycoside, which including alkyl polyglucosides (APGs). Alkyl glycosides include several commercial surfactants collectively known in the art or referred to herein as “alkyl polyglucosides” or “APGs”. Exemplary alkyl glycosides are Agrimul™ PG-2069 (Henkel), Agrimul™ PG-2076, and Eucarol™ AGE.

Another surfactant type that can be present in the aqueous concentrate is an alkoxylated phosphate ester, such ethoxylated phosphate esters. Examples include phosphate esters of alkylphenoxy polyethoxyethanol, and phosphate esters of alkylphenol ethoxylates. Commercially available ethoxylated phosphate ester surfactants include Stepfac™ 8170 (Stepan Co., Northfield, Ill.) and Emphos™ (Witco Chemicals, of Brooklyn, N.Y.)

Another surfactant type that can be present in the aqueous concentrate is an alkyldimethylamine. Examples include cocodimethylamine, tallowdimethylamine, dodecyldimethylamine. Commercially available alkyldimethylamines include Armeen™ DM12D (AkzoNobel) as Noram™ DMC or DMS (Ceca) respectively.

Another surfactant type that can be used in the present in the aqueous concentrate is a disulfonate surfactant. Examples of disulfonate surfactants include salts of alkyl diphenyl ether disulfonates and salts of alkyl diphenyl oxide disulfonates. Exemplary disulfonates include Dowfax 3B2™ (Dow Chemicals, Midland, Mich.) and Fenopon C0436™ (GAF Corp., New York, N.Y.).

Another surfactant type that can be used in the present in the aqueous concentrate is a poloxamer (a polyalkylene derivative of propylene glycol), such as Pluronic F68™ (BASF, Parsippany, N.J.).

Other surfactant types that can be present in the aqueous concentrate are alkylbetaines and alkyletherbetaines. A specific example of an alkylbetaines is cocobetaine, available as Velvetex™ AB-45 (Henkel) or Tego™ Betaine F 50 (Goldschmidt).

The resulting aqueous concentrate has a good viscosity, which allows the aqueous concentrate to be handled with greater ease.

The viscosity of the aqueous concentrate can be determined using standard techniques. Test guidelines for viscosity measurement can be carried out according to EPA guidelines 830.7100. Equipment for determination of viscosity can include, for example, a Brookfield Viscometer LVT, with a number 3 spindle. The speed setting knob can be placed at 60/3, and the viscosity of the aqueous concentrate can be measured at room temperature. In some aspects, the aqueous concentrate has a viscosity in the range of about 50 centistokes (cSt) to about 450 cSt, about 100 cSt to about 375 cSt, about 150 cSt to about 300 cSt, about 175 cSt to about 275 cSt, or about 200 cSt to about 250 cSt.

The aqueous concentrate also displays good storage stability. One test of storage stability is to determine the temperature of phase separation of the concentrate. Phase separation can be measured by cloud point, which is the temperature at which phase separation of materials in a herbicide composition occurs. As a general matter, for commercial acceptability, herbicide concentrates have a cloud point of about 50° C. or greater. In some aspects, the aqueous concentrate does not show signs of clouding at temperatures below about 60° C.

Optionally, excipients other than the surfactant can be included in the aqueous concentrate. However, if included, they are desirably kept at lower concentrations to allow for a very high concentration of the glyphosate salt in the aqueous concentrate. Other optional excipients that can be included in the composition include, but are not limited to antifoam agents, compatibilizing agents, sequestering agents, neutralizing agents and buffers, corrosion inhibitors, dyes, odorants, penetration aids, wetting agents, spreading agents, dispersing agents, thickening agents, freeze point depressants, antimicrobial agents, crop oil, and the like. These optional excipients can alternatively be introduced into an application composition when the aqueous concentrate is diluted prior to use.

An “application composition” refers to a diluted form of the aqueous concentrate which has a glyphosate salt concentration useful for controlling the growth, or killing one or more desired plant species. To provide an application composition, the aqueous concentrate can be diluted with water to provide for a desired application concentration of glyphosate salt. The application concentration of glyphosate salt can be chosen by one or more factors, such as the type of vegetation to be treated, the rate of application of the application composition, and the use of one or more other excipients which may enhance the function of the glyphosate salt, or improve properties of the application composition.

The application composition can then be applied to foliage of plants to be killed or controlled. Spraying is a common method for applying the application compositions to foliage. For application, the application composition can be applied in any convenient volume of water. Typical ranges are from about 50 L/ha to 1,000 L/ha. Common amounts of glyphosate (a.e.) used in method for controlling plant growth are in the range of about 0.1 to about 5 kg/ha, and more preferably about 0.5 to about 2 kg/ha.

The herbicide application compositions are highly effective against a variety of weeds, including dicot and monocot weed species. Weed varieties include, but are not limited to kochia, ryegrass, sedge (cyperus), pigweed, foxtail, barnyard grass, quack grass, wild oat, wild poinsettia, velvet leaf, morning glory, lambs quarter, and sicklepod.

Application compositions made from the aqueous concentrates of the current invention provide improved biological activity compared to application compositions prepared from aqueous glyphosate salt concentrates known in the art. The improved biological activity of the application compositions described herein is thought to result from a greater concentration of the biologically effective glyphosate salt form, which is carried over from the aqueous concentrate. In other words, as a percentage of solid materials in an application composition, the compositions of the invention (application compositions, as well as aqueous concentrates and high strength concentrates) contain a high percentage of biologically active glyphosate salt. As a result, the aqueous concentrates of the invention are effective in forming application composition with high biological activity for controlling the growth of one or more plant species.

Generally, biological activity of an application composition can be determined under controlled field conditions applying scientific methods and processes as generally accepted by the Weed Science Society of America. The biological activity of an application composition of the current invention can be determined by treating plant species in a standard field trial. Application compositions are standardized according to the calculated acid form of the glyphosate (a.e.) in the composition, are generally based on the glyphosate salt content (a.i.) of the aqueous concentrate.

According to one mode of practice, a test for biological activity can be performed using the following steps. First, an application composition is prepared from an aqueous concentrate of the invention. The application composition can have a concentration of glyphosate commonly used for the control of plant growth. The application composition is then applied to an area of ground having one or more or the following weed types: kochia, ryegrass, sedge (cyperus), barnyard grass, sicklepod, pigweed, foxtail, and/or in a post emergent manner. Alternatively, the application composition is applied to an area of ground capable of growing one or more or the following weed types: kochia, ryegrass, sedge (cyperus), barnyard grass, sicklepod, pigweed; foxtail, and/or in a pre-emergent manner. At day 0, the application composition is applied to provide an amount of glyphosate (a.e.) of 0.454 kg per acre At day 21 the area that is treated with the application composition is assessed to determine the control over plant growth.

Using this method, the application compositions of the invention are able to control the growth of one, or more, or all of the plant species (kochia, ryegrass, sedge (cyperus), barnyard grass, sicklepod, pigweed, and/or foxtail) by about 80% or greater, such as in the range of about 80% to about 100%. For example, using this method, the control of rye grass growth is about 80% or greater, such as in the range of about 80% to about 85%. As another example, the control of cyperus growth is about 90% or greater, such as in the range of about 90% to about 95%. As another example, the control of barnyard grass growth is about 90% or greater, such as in the range of about 90% to about 95%. As another example, the control of pigweed growth is about 90% or greater, such as in the range of about 90% to about 95%. As another example, the control of sicklepod growth is about 92% or greater, such as in the range of about 92% to about 98%. As another example, the control of kochia growth is about 95% or greater, such as in the range of about 95% to about100%. As another example, the control of foxtail growth is about 95% or greater, such as in the range of about 95% to about 100%.

Generally, the application composition of the invention provides visual ratings of 80% efficacy or greater, and are tested against Duncan's New Multiple Range Test. Range values followed by the same letter are generally considered not statistically different and hence not scientifically different. Table 1 shows the control of growth of various weed species using application compositions formed from commercially available glyphosate-containing herbicide concentrates and from concentrates of the current invention.

### Example 1

Herbicide application compositions were prepared from aqueous concentrates of the present invention, and also from commercially available glyphosate concentrates. Helosate™ formulations are aqueous concentrates prepared according to the present invention. PowerMAX™ (Monsanto), Touchdown™ (Syngenta), Glyfos Extra™ (Cheminova), and Credit Extra™ (Nufarm Americas) were used to prepare application compositions for comparative testing.

Table 1 shows comparison of application composition prepared from various commercial concentrates products on various weed species. The following weed species are abbreviated as follows: ECHCG (barnyard grass), CASOB (sicklepod), AMAXX (pigweed), and SETXX (foxtail). Application compositions were applied to plant species containing in an application amount of 0.454 kg a.e. glyphosate/acre (1 lbs./acre; 1.125 kg/ha). The numbers to the right of the herbicide formulations represent percentage control of the identified plant species at 7 and 21 day time points.

TABLE 1

| | ECHCG | ECHCG | CASOB | CASOB | AMAXX | AMAXX | SETXX |
|---|---|---|---|---|---|---|---|
| | 7 DAT | 21 DAT | 7 DAT | 21 DAT | 7 DAT | 21 DAT | 7 DAT |
| Helosate ™ 70 | 74 | 92 | 81 | 95 | 71 | 93 | 85 |
| PowerMAX ™ | 69 | 94 | 83 | 96 | 69 | 91 | 81 |
| Touchdown ™ | 55 | 83 | 74 | 89 | 55 | 84 | 83 |
| Helosate ™ | 81 | 96 | 80 | 96 | 73 | 98 | 89 |
| Plus | | | | | | | |
| Glyfos Extra ™ | 77 | 86 | 78 | 90 | 65 | 91 | 77 |
| Credit Extra ™ | 72 | 90 | 83 | 84 | 61 | 88 | 88 |
| LSD .05 | 8 | 7 | 6 | 9 | 11 | 6 | 12 |

| | SETXX | Kochia | Kochia | Ryegrass | Ryegrass | Cyperus | Cyperus |
|---|---|---|---|---|---|---|---|
| | 21 DAT | 7 DAT | 21 DAT | 7 DAT | 21 DAT | 7 DAT | 21 DAT |
| Helosate ™ 70 | 98 | 64 | 98 | 45 | 81 | 40 | 91 |
| PowerMAX ™ | 99 | 66 | 97 | 41 | 76 | 42 | 93 |
| Touchdown ™ | 91 | 51 | 88 | 35 | 74 | 40 | 97 |
| Helosate ™ | 99 | 65 | 99 | 49 | 75 | 35 | 88 |
| Plus | | | | | | | |
| Glyfos Extra ™ | 95 | 59 | 95 | 45 | 78 | 42 | 89 |
| Credit Extra ™ | 96 | 61 | 99 | 40 | 70 | 38 | 94 |
| LSD .05 | 8 | 10 | 4 | 12 | 9 | 11 | 5 |

What is claimed is:

1. A surfactant-containing aqueous glyphosate salt concentrate comprising a primary amine salt of glyphosate at a concentration in the range of 45 percent weight to 68 percent weight, and a surfactant at a concentration in the range of 3 percent weight to 27 percent weight, wherein the concentrate has a viscosity in the range of 40 to 450 centistokes.

2. The surfactant-containing aqueous glyphosate salt concentrate of claim 1 wherein the primary amine salt of glyphosate salt is at a concentration in the range of 50 percent weight to 68 percent weight.

3. The surfactant-containing aqueous glyphosate salt concentrate of claim 2 wherein the primary amine salt of glyphosate salt is at a concentration in the range of 60 percent weight to 67 percent weight.

4. The surfactant-containing aqueous glyphosate salt concentrate of claim 1 wherein the surfactant is at a concentration in the range of 3 percent weight to 7 percent weight.

5. The surfactant-containing aqueous glyphosate salt concentrate of claim 4 wherein the surfactant is at a concentration in the range of 4 percent weight to 6 percent weight.

6. The surfactant-containing aqueous glyphosate salt concentrate of claim 1 having a viscosity in the range of 150 to 300 centistokes.

7. The surfactant-containing aqueous glyphosate salt concentrate of claim 1 wherein the primary amine salt of glyphosate comprises glyphosate-monoisopropylammonium.

8. The surfactant-containing aqueous glyphosate salt concentrate of claim 1 having a cloud point of not below 60° C.

9. The surfactant-containing aqueous glyphosate salt concentrate of claim 1 wherein the surfactant is selected from the group consisting of alkoxylated alkyl amine, quaternary ammonium, alkyl glycoside, ethoxylated phosphate ester, alkyldimethylamine, disulfonate, poloxamer, and alkylbetaine surfactants.

10. The surfactant-containing aqueous glyphosate salt concentrate of claim 9 wherein the surfactant comprises a polyalkoxylated tallowamine.

11. The aqueous glyphosate salt concentrate of claim 9 wherein the surfactant comprises a polyethoxylated alkyl amine.

12. A method for preparing a surfactant-containing, aqueous glyphosate salt concentrate comprising steps of:
(a) providing a glyphosate acid preparation comprising glyphosate acid, and a having water content of 35 percent weight or less;
(b) providing a primary amine preparation comprising a primary amine at 70 percent weight or greater;
(c) combining water with the glyphosate acid preparation to provide a glyphosate acid slurry, wherein the amount of water combined is in the range of 25% to 35% of a total amount of material from the glyphosate acid preparation and primary amine preparation added in step (d);
(d) adding the primary amine preparation to the glyphosate acid slurry, wherein the primary amine reacts with the glyphosate acid to form a primary amine salt of glyphosate, thereby producing a high-strength glyphosate salt aqueous concentrate; and
(e) combining a surfactant composition with the high-strength glyphosate salt aqueous concentrate to form a surfactant-containing, aqueous glyphosate salt concentrate, wherein surfactant is present in the surfactant composition in an amount of greater than 50 percent weight.

13. The method of claim 12 wherein the glyphosate acid preparation has a water content of 5 percent weight or less.

14. The method of claim 12 wherein the primary amine preparation comprises the primary amine at 95 percent weight or greater.

15. The method of claim 12, wherein the surfactant is present in the surfactant composition in an amount in the range of 70 to 100 percent weight.

16. The method of claim 12, further comprising a step of adding additional water to provide a high-strength glyphosate salt aqueous concentrate comprising the primary amine salt of glyphosate in an amount in the range of 63 percent weight to 70 percent weight, wherein adding additional water is performed between step (d) and (e).

17. The method of claim 12, wherein on completion of step (d), greater than 90 percent of the glyphosate acid in the glyphosate acid slurry reacts with the primary amine to form the primary amine salt of glyphosate.

18. The method of claim 12, wherein the glyphosate acid preparation has a water content of 2 percent weight or less.

19. The method of claim 12, wherein the primary amine is present in the primary amine preparation at 99 percent weight or greater.

20. The method of claim 12, wherein step (c) the amount of water combined is in the range of 27.5% to 32.5% of a total amount of material from the glyphosate acid preparation and primary amine preparation combined in step (d).

21. The method of claim 12, wherein step (d), primary amine is added to the to the glyphosate acid slurry at a rate in the range of 2.1% to 3.2% per minute.

22. The method of claim 12, wherein the high-strength glyphosate salt aqueous concentrate temperature formed in step (d) is kept at a temperature in the range of 90° F. to below 140° F.

23. The method of claim 12, wherein step (d), the primary amine preparation is added to the glyphosate acid slurry to provide a weight ratio of primary amine to glyphosate acid in the range of 0.27:1 to 0.33:1

24. The method of claim 12, further comprising a step of filtering the high-strength glyphosate salt aqueous concentrate, wherein filtering is performed is performed between step (d) and (e).

25. The method of claim 24, wherein the step of filtering comprises removing particulates that are greater that 1 μm.

26. The method of claim 12, wherein the glyphosate acid preparation has one or more of the following features: less than 1 percent weight formaldehyde, less than 1 percent weight nitrosamines.

27. A method for preparing a surfactant-containing, aqueous glyphosate salt concentrate comprising steps of:
(a) providing a high-strength glyphosate salt aqueous concentrate comprising a primary amine salt of glyphosate in an amount of 63 percent weight or greater, wherein the concentrate comprises less than 1 percent weight unreacted glyphosate acid, or a high-strength glyphosate salt aqueous concentrate comprising a primary amine salt of glyphosate in an amount of 63 percent weight or greater, wherein the concentrate comprises less than 1 percent weight glyphosate particulates of a size greater than 1 μm, and
(b) combining a surfactant composition with the high-strength glyphosate salt aqueous concentrate to form a surfactant-containing, aqueous glyphosate salt concentrate, wherein surfactant is present in the surfactant composition in an amount of greater than 50 percent weight.

28. A method for preparing a herbicide application composition comprising a step of diluting the surfactant-containing, aqueous glyphosate salt concentrate of claim 1 with water.

29. A method for controlling vegetation comprising applying to plants in a post emergent or pre-emergent manner an application composition prepared according to claim 28.
